(19) United States
(12) Patent Application Publication
(10) Pub. No.: US 2002/0155267 A1
(43) Pub. Date: Oct. 24, 2002

(54) Multi-layer hermetically sealable film

(76) Inventor: Michael John Bader, Fairport, NY (US)

Correspondence Address: ExxonMobil Chemical Company, P.O. Box 2149, Baytown, TX, 77522, US

(21) Appl. No.: 09/791,325

(22) Filed: Feb. 22, 2001

(51) Int. Cl. B32B 7/02; B32B 15/08; B32B 27/08; B29C 55/00

(52) U.S. Cl. 428/216; 428/220; 428/516; 428/910; 428/461; 264/173.14; 264/173.15

(57) ABSTRACT

A thermoplastic multi-layer film for forming hermetic seals on packages comprising layer B comprising polypropylene and a softening additive; and layer C comprising a copolymer.

### BACKGROUND OF THE INVENTION

1. Field of the Invention

The present invention relates to the art of packaging using multi-layer films, and, in particular, to a new composite multi-layer film for providing hermetic seals to multi-layer film packages.

2. Description of the Prior Art

Packaging technology has over the years required the development of many disciplines. Currently, packaging technologies integrate elements of engineering, chemistry, food science, metallurgy, and other technologies in order to provide the consumer fresh food product. In those cases where packages are prepared from multi-layer film, it is desirable to be able to provide a hermetic seal, i.e., a seal which does not permit passage of gas such as air.

In recent years, containers produced out of multiple-layer flexible film, such as bags and pouches, predominate the marketplace. In order to utilize continuous multiple-layer flexible film, the industry generally employs form/fill/seal packaging techniques. The type of product packaged dictates whether or not the technique will include horizontal form/fill/seal packaging (HFFS) or vertical form/fill/seal packaging (VFFS).

It is important for the packaging artisan to be able to select a multi-layer film having optimum barrier properties for storage of the food items and be confident of providing a high quality seal using high speed packaging apparatus. For example, it is known that stereoregular polypropylene, e.g., oriented polypropylene, is quite useful in the manufacture of packages from flexible films. Using oriented polypropylene as a core layer, additional layers in the way of coatings, co-extrusions, laminations, and combinations thereof are added to improve barrier properties of the film. In certain cases, films can be prepared which exclude moisture and oxygen, but permit the passage of light. In other cases, it is also important to prevent light from passing through the film barrier. Barrier properties can also be modified and/or enhanced by treatments such as heat and flame treatment, electrostatic discharge, plasma treatmemt, chemical treatments, halogen treatment, ultraviolet light, and combinations thereof.

A primary concern for designing multiple-layer films for packaging is to ensure they can be processed on high speed form/fill seal machinery. Form/fill/seal package apparatus operates by unwinding continuous film from bulk film rolls, followed by forming pouches therefrom, filling the pouches, and finally, sealing the pouch closed. Thus, the film must have sufficient flexibility to undergo machine folding from a flat orientation to a folded condition, and be subjected to a sealing function which is part of high-speed packaging apparatus. In selecting the optimum multi-layer film for its barrier properties, high-speed unrolling and folding are the primary concern. An additional, and very important aspect of the packaging process, however, is the ability to effectively seal the pouch after it is filled with the product.

High-speed horizontal and vertical form/fill/seal apparatus include sealing functions at various stages of the packaging process. In a horizontal form/fill/seal apparatus, individual pouches are formed by folding the multi-layer film in half followed by providing vertical seals along the length of the folded web and separating the pouches along the seals formed by vertical sealing. (Optionally, the bottoms of the pouches can also be sealed). After the pouch thusly formed is filled, the top of the pouch is sealed.

Similarly, in vertical form/fill/seal apparatus, the continuous web is formed around a tube and the web is immediately joined together by a longitudinal sealing jaw as either a lap seal or a fin seal. Lap seals and fin seals are depicted in U.S. Pat. No. 5,888,648. U.S. Pat. No. 5,888,648 is incorporated herein by reference in its entirety.

A second sealing function is present in a VFFS configuration which consists of a combination top- and bottom-sealing section (with a bag cut-off device in between). The top-sealing portion seals the bottom of an empty bag suspended from the bag forming tube while the bottom portion seals the top of a filled bag.

In order, therefore, to provide high-barrier multi-layer film with hermetic seals, several factors must be considered. It is important to provide a sealing capability at as low a temperature as possible in order to retain, among other things, stereoregularity imposed during orientation, little or no film shrinkage, retention of film and/or chemical additive properties, and highly consistent quality sealing capabilities. Furthermore, the film must have surface characteristics which permit it to be readily used on high-speed machinery. For example, the coefficient of friction must be such that it can be readily unrolled from a high volume roll of film and passed through the packaging machinery. Undesirable sticking or friction characteristics can cause bag imperfections and interruption of high-speed processing. Moreover, seals formed during process must have good seal strength.

More recently, the packaging artisan has been concerned with the ability to provide quality seals which preserve the freshness of the contents while providing the consumer with an easily openable and reclosable container. Innovations to date have been primarily concerned with the components of the seal material.

U.S. Pat. No. 3,202,528 describes an oriented polypropylene film having an adherent heat-sealable coating which includes a material from the group consisting of copolymers of vinylidene chloride and acrylonitrile, copolymers of vinyl chloride with vinyl acetate, chlorinated rubbers, nitrocellulose and polyamide which melts below 160° C. and an acidic material provided in an amount of about 20 to about 60% by weight of the film forming material. This adhesive is coated and dried on the film. U.S. Pat. No. 3,202,528 is incorporated herein by reference in its entirety.

U.S. Pat. No. 4,020,228 describes a gel composition which provides a heat sealable surface to polyolefinic materials or cellulosic sheet materials. U.S. Pat. No. 4,121,956 discloses an ionomer adhesive adhered to an outer ionomeric surface of package wrapping for attachment of labels. U.S. Pat. No. 4,020,228 is incorporated herein by reference in its entirety.

U.S. Pat. No. 4,218,510 discloses a heat-sealable multi-layer film having a polyester layer chemically interfacially bonded to a polyolefinic layer which contains 250 to 750 parts per million of a fatty acid amide. U.S. Pat. No. 4,218,510 is incorporated herein by reference in its entirety.

U.S. Pat. No. 4,292,882 discloses an oriented heat-sealable anti-static polypropylene film manufactured by applying to a surface of a base polypropylene film a heat-sealable olefinic polymer containing between 0.2 and 10% by weight of an anionic hydrocarbyl sulfonate. Andrews, et al. also provide that a slip agent can be incorporated for ease of handling. U.S. Pat. No. 4,292,882 is incorporated herein by reference in its entirety.

U.S. Pat. No. 4,389,450 describes a multi-layer packaging film in which the outer polymeric layers cooperate to provide a relatively constant coefficient of friction differential. This enhances the ability to use the film in high speed processing to form fin seal and lap seals. U.S. Pat. No. 4,389,450 is incorporated herein by reference in its entirety.

U.S. Pat. No. 5,049,436 discloses a multi-layer film which is hermetically heat sealable over a broad temperature range. This patent describes a heat-sealable layer which includes an ethylene-propylene copolymer and/or an ethylene-propylene-butene terpolymer with an inorganic anti-block agent and a fatty acid amide. U.S. Pat. No. 5,049,436 is incorporated herein by reference in its entirety.

U.S. Pat. 5,376,437 describes a three-layer, heat sealable film having a base layer of biaxially oriented, crystalline polypropylene, a cushion layer of an olefin polymer lower in melting point than the base layer, and a heat-sealable layer of an olefin polymer. The various layers of this film have particular degrees of surface orientation. U.S. Pat. No. 5,376,437 is incorporated herein by reference in its entirety.

U.S. Pat. No. 5,527,608 describes a biaxially oriented heat sealable multilayer film which has a core substrate of a polyolefin homopolymer. On one surface of the core substrate is a layer of a block copolymer of ethylene and propylene having a melt flow ratio (MFR) of 1 to 10. A high density polyethylene layer may be placed on the other surface of the core substrate, and a heat sealable layer may be placed over the block copolymer layer. The heat sealable layer may be formed from a terpolymer of ethylene, propylene and butene-1, a random copolymer of ethylene and propylene, a random copolymer of propylene and butene-1 or blends thereof. U.S. Pat. No. 5,527,608 is incorporated herein by reference in its entirety.

U.S. Pat. No. 5,888,648 describes a multi-layer, hermetically sealable film. The main film substrate may be oriented polypropylene, optionally having a layer of high density polyethylene on one surface of the polypropylene. On the surface of the polypropylene opposite the high density polyethylene layer is an intermediate layer of polyethylene homo-, co- and terpolymers, amorphous nylon, ionomers or mixtures thereof. A preferred polymer in the intermediate layer is low density polyethylene. On the exterior surface of the intermediate layer is a sealing layer of, e.g., polyethylene homo-, co- and terpolymers, amorphous nylon, ionomers or mixtures thereof. U.S. Pat. No. 5,888,648 is incorporated herein by reference in its entirety.

U.S. Pat. No. 6,058,680 describes an apparatus and method for forming a hermetically sealed package for a slice of a food item. A web of thermoplastic material is first formed into a tubular arrangement with a hermetic longitudinal seal. To form the tubular arrangement, means are provided for folding a continuous web of thermoplastic material into V-folded condition and for continuously forming a hermetic seal along the open longitudinal edge of the V-folded web. The hermetic seal is formed between the inner surfaces of the front and rear faces of the web to define a tubular web member. The food item which has been formed into a soft mass, is then inserted into the tubular member and the tubular member is flattened to form a thin film tube. Means are provided for forming a hermetically sealed cross-seal which are disposed substantially transverse to the longitudinal forward moving direction of the web. U.S. Pat. No. 6,058,680 is incorporated herein by reference in its entirety.

Copending U.S. application Ser. No. 09/435,559 filed Nov. 8, 1999 to Kong et al discloses a multi-layer film having an improved composite structure for providing hermetic seals to packages manufactured in high speed packaging apparatus. The structure of the multi-layer film includes layers A/B/C/D. Skin layer A is formed from polypropylene copolymer with melt flow rate greater than one or linear high density polyethylene with melt index greater than one. Core layer B is formed from polypropylene. Intermediate layer C has the primary function of compliance during sealing, and sealing layer D has the primary function of providing adhesivity to the completed seal. The sealing layer D includes an antiblocking agent comprising non-distortable organic polymer particles having an average particle size greater than 6 microns. Copending U.S. application Ser. No. 09/435,559 is incorporated herein by reference in its entirety.

### SUMMARY OF THE INVENTION

The present invention provides a thermoplastic multi-layer film for forming hermetic seals on packages comprising layer B comprising polypropylene and a softening additive; and layer C comprising a copolymer.

### DETAILED DESCRIPTION OF THE INVENTION

The present invention provides a multi-layer film and a method of improving multi-layer films whereby hermetic seals can be simply and efficiently formed and whereby excellent seal characteristics are achieved.

The present invention includes a core layer B of oriented polypropylene. It is noted that such a polypropylene layer B alone (without additional layers) characteristically has a stiffness or modulus which prevents or significantly reduces the ability to seal the film together where the film is bent to form overlaps or fins. In one embodiment the layered film has good barrier properties and can include a metallized film layer. For example, the layered film can include one or more additional layers selected from the group consisting of oriented polypropylene, ethylene-propylene copolymers, polyethylene terephthalate, polyamide, polyacrylonitrile copolymer, polyvinylidene chloride, fluoro-polymers, ethyl-vinyl alcohol copolymers, and mixtures thereof. Other layers can be barrier resins, tie resins, metallized film, ceramic deposited film (e.g., SiO₄), plasma chemical vapor deposited film, and metal, ceramic, plasma chemical vapor.

The layered film may be laminated through skin layer A to additional outer webs, such as oriented polypropylene (OPP), polyethylene terephthalate (PET), polyamide, polyethylene, and other mono- or multi-layer films. Layer A can also be metallized and then laminated, through the metal layer, to other films, such as a multi-layer biaxially oriented polypropylene film.

Layer C provides a sealing function and is bonded to layer B. These layers include a layer C, which is directly bonded to layer B.

In one embodiment, the C layer should has sufficient thickness and has sufficient flow property under sealing conditions to deform and comply with all unfilled space between the sealing jaws during sealing. The term “comply” means to be easily and inelastically forced to occupy all empty space remaining between sealing jaws while the sealing jaws are in the closed or seal position.

Polyethylene or polypropylene co- and terpolymers are contemplated for use in the layer C. The layer C material should flow under heat and pressure imposed by jaws of commercial sealing apparatus to occupy all the space between the jaws.

In another embodiment, the layer C may further comprise inorganic particles, such as solid oxides, having an average particle size greater than 2 microns. These inorganic particles of the layer C may be composed of silica (SiO₂), metal carbonates (including alkali metal carbonates, such as calcium carbonate), metal silicates (including alkali metal silicates, such as magnesium silicate, and other metal silicates, such as aluminum silicate), metal phosphates (including alkali metal phosphates, such as calcium phosphate), clays, talc, diatomaceous earth, glass and the like. Examples of inorganic blocking materials include the Syloids, available from W. R. Grace Davison Division, synthetic amorphous silica gels having a composition of about 99.7% SiO₂ and a particle size of about 2-4 microns, particularly Syloid 244, having a particle size of about 2.0 microns. Also useful are Super Floss, from World Minerals, a diatomaceous earth of the composition SiO₂ 92%, Al₂O₃ 44%, Fe₂O₃ 1.2%, having an average particle size of about 5.5 microns; and synthetic precipitated silicates such as Sipernat 44, available from Degussa Corporation of Akron Ohio, having a composition of SiO₂ 42%, Al₂O₃ 36%, Na₂O 22% and having a 3.5 micron mean particle size.

In another embodiment, the particle size of the optional inorganic particles of the antiblocking agent may be from 1 microns to 15 microns, in a second embodiment from 2 microns to 8 microns, and in a third embodiment about 4 microns. The loading of the inorganic particles in the layer C may be from 600 ppm to 5,000 ppm, in a second embodiment from 1,000 ppm to 3,000 ppm, and in a third embodiment from 1,500 ppm to 2,500 ppm.

In another embodiment, the polypropylene of layer B may be the homopolymer Fina 3371 sold by the Fina Oil Company. The polypropylene of layer B may be a homopolymer or a copolymer. Propylene homopolymers for layer B include isotactic polypropylene, in a second embodiment 80-100% isotactic polypropylene, and in a third embodiment about 95% isotactic polypropylene. In another embodiment, the propylene homopolymers may have a melt flow (measured in accordance with the standard ASTM D1238 method) ranging from about 1.2 to about 10 g/10 minutes, and in another embodiment from about 2.5 to about 6 g/10 minutes. Particular propylene copolymers include (98-93)/(2-7) propylene/ethylene copolymers.

In another embodiment an additive or polymer is added to layer B. The additive or polymer serves to soften or make layer B act as more of a compliant layer for layer C. Any additive or polymer that serves to soften or make the polypropylene of layer B more compliant is contemplated for use in this invention. Specific additives and polymers that may be used include ethylene-propylene copolymers, other copolymers and terpolymers, thermoplastic hydrocarbons, hydrocarbon resins, and cyclopentadiene hydrocarbon. In one embodiment, the additive is a hydrocarbon resin. In a second embodiment the additive is a cyclopentadiene hydrocarbon. In another embodiment the additive has a low softening point, below 140 degrees centigrade. In another embodiment the additive has a softening point below 100 degrees centigrade. In one embodiment the additive or polymer comprises up to about 20% by weight of layer B. In a second embodiment, the additive or polymer comprises from about 2% up to about 15% by weight of layer B. In a third embodiment, the additive or polymer comprises from about 4% up to about 8% by weight of layer B.

In one embodiment, layer A comprises a linear high density polyethylene having a density of greater than 0.945 g/cc, e.g, about 0.945 to about 0.965 g/cc. It is well known that the density of polyethylene is decreased by copolymerizing ethylene with other olefins, especially those having four or more carbon atoms. Therefore, in another embodiment, it will be understood that the linear high density polyethylenes are free or substantially free of other comonomers. It is also well known that linear high density polyethylenes can be prepared with a variety of coordination-type catalysts.

As described in U.S. Pat. No. 5,929,128, linear high density polyethylene is essentially free of long chain branching. U.S. Pat. No. 5,929,128 is incorporated herein by reference in its entirety.

In another embodiment, layer A comprises a medium density polyethylene having a density of greater than 0.935 g/cc, e.g, about 0.935 to about 0.945 g/cc.

In one embodiment, the copolymer of layer C may be a copolymer of propylene with one or more olefins, such as ethylene and C₄ to C₁₀ alpha-olefins. Such polypropylene copolymers may include at least 80 mole % of propylene.

In another embodiment, the layer C thickness may be from 3 microns to 15 microns, in a second embodiment from 5 microns to 10 microns, and in a third embodiment from 7 microns to 9 microns.

In another embodiment, the layer B thickness may be from 5 microns to 25 microns, in a second embodiment from 8 microns to 20 microns, and in a third embodiment from 10 microns to 15 microns.

In one embodiment, the layer A thickness may be from 0.5 microns to 15 microns, in a second embodiment from 1 microns to 10 microns, and in a third embodiment from 3 microns to 8 microns.

In another embodiment, the multi-layer film comprising layers A, B, and C may be uni-axially or bi-axially oriented.

In another embodiment, Layer C may have a thickness of from about 15% to about 70% of the total thickness of layers A, B, and C, for example, from about 20% to about 60% of this total thickness.

The present invention provides a multi-layer film which is hermetically sealable and a method of improving the seal characteristics of multi-layer films which are hermetically sealable in high-speed packaging machines. In order to provide a hermetic seal to packages formed from multi-layer films, care must be taken to provide a sealing medium which accommodates the nature of the barrier film used for the package, i.e., its modulus or stiffness, thickness, adversity to temperature and pressure imposed under sealing conditions, etc. “Hermetic seals” as used herein means both peelable and unpeelable seals which provide hermetic barrier properties, i.e., does not permit passage of a gas.

As pointed out in U.S. Pat. No. 5,888,648, two separate layers may be used to provide a sealing function. Each layer is primarily designed to fulfill one of the required sealing functions, and certain imperfections in hermetic seals normally associated with high-speed film packaging can be avoided. Specifically, the core layer (layer B) primarily meets the requirement of “compliance” throughout the volume between the surfaces of sealing jaws of high-speed packaging apparatus during the sealing function. Another layer (layer C), on the other hand, primarily meets the requirement of providing high performance adhesion under sealing conditions. Bearing in mind that sealing conditions include both high temperature and pressure imposed on the core and outside layer, both the core and outside layer will participate in both of the sealing functions, i.e., compliance and adhesion. However, the primary function of the core layer (layer B) is to provide compliance while the primary responsibility of the outside layer (layer C) is to provide adhesivity. Thus, the composition of the outside layer is usually different from the composition of the core.

Since the primary function of the core layer (layer B) is compliance between the sealing jaws, the outside layer should have two attributes to fulfill its function, sufficient thickness and a flow property to comply with the space between the jaws.

“Compliance” in the context of the present disclosure means the ability to be easily and non-elastically deformed to fill and conform to the entire space between the sealing surfaces of a sealing jaw. Sealing jaws can operate from a temperature of from about 120° C. to about 190° C., and normally are imposed on a film packaging material at a pressure of from about 120 psi to about 180 psi.

Sealing jaws are illustrated and described in U.S. Pat. No. 5,888,648. Sealing jaws can be flat, or, in many cases, are provided with teeth. A complementary jaw is used in conjunction with a sealing jaw such that the teeth of the sealing jaw mesh with the valleys the complementary jaw. The surfaces of the jaws close in the sealing position on two multi-layer films, thereby clamping the films therebetween. To form a hermetic seal, the volume between the surfaces must be completely filled during sealing. These are the normal sealing conditions under which the core layer must be capable of compliance.

The core layer should have sufficient material to undergo compliance without leaving a void. Thus, the thickness of the core layer should be such that a continuum of material is provided throughout the space between the surfaces of the sealing jaw. The flow property of the core layer should be such that in the presence of the temperature and pressure exerted during sealing, the material maintains a viscosity which is easily deformed but maintains a non-interrupted mass throughout the space between the sealing surfaces.

In one embodiment, random copolymers of ethylene and propylene or a random terpolymer of ethylene-propylene-butylene (EPB) have been found to be excellent components for the outside layer C. These components are inexpensive and have the correct adhesive requirements for layer C. These components can be used alone or in combination with other components, such as linear low density polyethylene.

In another embodiment, the outside layer (layer C) has the primary responsibility of providing adhesivity. Thus, the components of the outside layer should be selected based on their ability to provide good adhesive seal strength, i.e., adequate tensile strength of the seal. Inasmuch as the primary function of the outside layer is that of adhesivity, the thickness of the outside layer is less than the thickness of the core layer (layer B). The outside layer can optionally include organic and/or inorganic antiblocks to facilitate film machinability.

### Definition of terms

1. 1 microns—A length of 1 millionth of a meter or 0.0000394 inches

2. Biaxially oriented—stretched in the machine direction, the direction of the feed, and in the transverse direction, perpendicular to the feed

3. Coating—A layer applied to an outside surface of the film

4. Coextruding—A process for producing a multi-layer film where the melted components of each layer are simultaneously fed through a die which stacks the layers on top of each other

5. Comprising—Made up of at least the named components (can also include other unnamed components)

6. Copolymer—An elastomer produced by the simultaneous polymerization of two or more dissimilar monomers, like 90% polyethylene and 10% polypropylene

7. Corona treating—A process involving an electrical discharge that causes the ionization of oxygen and the formation of ozone

8. Crimp seal—A join of two or more layers formed by applying heat and pressure to connect the layers

9. Elevated temperature—A temperature from about 100 to about 300 degrees Fahrenheit, or from about 38 to about 150 degrees Centigrade

10. Film—A thin material from about 10 to about 50 microns thick

11. Fin seal—A join of two or more layers formed by applying heat and pressure to connect the flaps of the layers

12. Flame treatment—A process involving a flame that causes ionization of oxygen

13. Hermetic seal—A seal which does not permit passage of gas (such as air)

14. High density polyethylene—A polyethylene having a density greater than about 0.945 grams per cubic centimeter

15. Lap seal—A join of two or more layers formed by applying heat and pressure to connect the overlap of the layers

16. Machine direction—Substantially parallel to the direction of the process feed

17. Medium density polyethylene—A polyethylene having a density from about 0.935 to about 0.945 grams per cubic centimeter

18. Metallized—A surface that has a metal coating applied (usually aluminum)

19. Minimum Seal Temperature (MST)—Minimum temperature that will produce a 200 gram seal (ASTM #F-88)

20. Mixture—A heterogenous association of substances that can not be represented by a chemical formula. Its components can usually be separated by mechanical means

21. Orienting film—Stretching film by pulling the ends in opposite directions

22. Plasma Treatment—A process involving a neutral mixture of positively and negatively charged particles interacting with an electromagnetic field

23. Polyethylene—A thermoplastic polymer produced by polymerizing primarily ethylene monomers

24. Polyethylene acrylic acid—A polymer formed from the polymerization of the monomers ethylene and acrylic acid

25. Polyvinylidene chloride—A stereoregular thermoplastic polymer produced by polymerizing vinylidene chloride and optionally with other unsaturated compounds. Also known as “saran”

26. Priming—A process to prepare the outside surface for a coating

27. Reverse direct gravure coating process—A process to apply a coating wherein cells are engraved into a roll surface (gravure roll), and coating is supplied to the rotating gravure roll from a pan, filling the cells and covering the roll surface, the excess is wiped off by a doctor blade. The gravure roll operates in the opposite direction to the web, and the nip is maintained at very light contact by adjustable roll stops. The wiping action blends the dots together, yielding uniform light coatings.

28. Thermoplastic—A high polymer that softens when exposed to heat and returns to its original condition when cooled to room temperature

29. Thickness—a caliper measurement

30. Transverse direction—Substantially perpendicular to the direction of the process feed

31. Uniaxially oriented—stretched in only one direction, either machine, in the direction of the feed, or in the transverse direction, in the direction perpendicular to the feed direction

### EXAMPLE 1A

The 90 gauge coextruded biaxially oriented film structure comprised a polypropylene core (Fina 3371), with a 25 gauge (6.3 micron) sealant layer of Chisso 7701 terpolymer. This sealant layer contained approximately 3,000 ppm of a non-migratory slip agent. The other skin layer was a metallizeable HDPE layer and flame treated to improve adhesion of a coating or aluminum to the film. 8% cyclopentadiene hydrocarbon (from a 40% masterbatch called OPPERA6114E1 or Exxon 6114E1 resin) was added to the PP core.

The resultant biaxially oriented coated film structures had the following sealing properties tested in the Quality Control Lab:

| | 200 | | | | | | | | |
|---|---|---|---|---|---|---|---|---|---|
| Core | gm/in | Crimp Seal Strengths (20 psi, ¾ sec.) * | | | | | | | |
| Resin | MST | 210 F | 220 F | 230 F | 240 F | 250 F | 260 F | 270 F | 280 F |
| PP Core | 214 | 120 | 400 | 950 | 800 | 850 | 900 | 830 | 1000 |
| 8% | 211 | 180 | 1150 | 1220 | 1000 | 1230 | 1000 | 1200 | 1300 |
| hydro- | | | | | | | | | |
| carbon | | | | | | | | | |
| in PP | | | | | | | | | |
| Core | | | | | | | | | |

* Note: seal strength values are in gms./in.

These films were also metallized and barrier properties were measured. Based on limited data, there was no effect on OTR or WVTR barrier properties with the addition of the CP hydrocarbon resin to the core.

Both 90 gauge metallized AIRTYTE** films were extrusion laminated to 75LBW and evaluated for hermetic sealability on the Fuji 7700 VFFS Packaging Machine. The AIRTYTE* hermetic seal range increased approximately 40% with the CP hydrocarbon in the PP core, compared to a 100% PP core. The hermetic seal range was 60 F×60 F (fin seal versus crimp seal range) with the hydrocarbon in the core. The “standard” 90 Airtyte lamination had a hermetic seal range of 50 F×50 F on the Fuji 7700, with 2.5 mm crimpers and 2.0 mm fin sealers. Package crimp seal strengths were also measured. The “standard” 90 AIRTYTE** lamination had a crimp seal strength of 1800-2000 gm./in. This seal strength was considered typical for this product designed based on prior testing. The package crimp seal strengths at the same sealing temperatures, with the 90 AIRTYTE** (with 8% hydrocarbon in the core), were measured to be 2600 to greater than 3000 gms./in.

### EXAMPLE 1B

Using the same laminations as in Example 1A, a packaging evaluation was also completed on a Wright Monobag 12-22 wrapper, which was considered a more difficult machine (compared to the Fuji 7700) to obtain a wide hermetic window. With the “standard” 90 AIRTYTE** lamination, there was no hermetic window. With the CP hydrocarbon in the core, the hermetic window increased to 20 F×30 F, which was considered a significant change compared to the “standard” AIRTYTE** lamination. This same or similar hermetic window was also observed with the competitive CPP/MET-PET/OPP structure and a “thicker sealant” AIRTYTE** variable.

### EXAMPLE 2

The same 90 gauge AIRTYTE** base film, as described in Example #1A or 1B, was made except the sealant layer was changed to Chisso 7791. The CP hydrocarbon additive was added to the core at a 6% level. Two films were made with and without the CP Hydrocarbon. The effect on the seal strengths were dramatic with the 6% hydrocarbon in the core. The seal strengths increased on average 700 gm./in. or approximately 40% with the addition of the CP hydrocarbon in the PP core compared to no additives in the core.

The resultant biaxially oriented coated film structures had the following sealing properties tested in the Quality Control Lab:

| Core | 200 gm/in | Crimp Seal Strengths (20 psi, ¾ sec.) * | | | | | | | |
|---|---|---|---|---|---|---|---|---|---|
| Resin | MST | 170 F | 180 F | 200 F | 220 F | 240 F | 260 F | 270 F | 280 F |
| PP Core | 174 F | 75 | 400 | 1150 | 1950 | 1200 | 2850 | 1450 | 1670 |
| 6% CP hydro- | 172 F | 115 | 575 | 1615 | 2300 | 1900 | 3000+ | 3000+ | 2000 |
| carbon in PP | | | | | | | | | |
| Core | | | | | | | | | |

* Note: seal strength values are in gms./in.

** Note: AIRTYTE films are disclosed in copending U.S. application Ser. No. 09/435,559 incorporated herein by reference in its entirety. An AIRTYTE film is a multi-layer film having an improved composite structure for providing hermetic seals to packages manufactured in high speed packaging apparatus. The structure of the multi-layer film includes layers A/B/C/D. Skin layer A is formed from polypropylene copolymer with melt flow rate greater than one or linear high density polyethylene with melt index greater than one. Core layer B is formed from polypropylene. Intermediate layer C has the primary function of compliance during sealing, and sealing layer D has the primary function of providing adhesivity to the completed seal. The sealing layer D includes an antiblocking agent comprising non-distortable organic polymer particles having an average particle size greater than 6 microns. Comparative Examples 1, 2, 3, and 4 below disclose specific embodiments of the AIRTYTE film:

### Comparative Example 1

A laminated film structure is prepared from a four layer coextruded biaxially oriented film having layers A, B, C, and D. Layer A of the four layer film is laminated with adhesive to biaxially oriented polypropylene film product (Mobil's 80 MB400). The four layer film is of the structure A/B/C/D, in which the skin layer A of the film is HDPE about 0.8 um thickness, the core layer B of the film is polypropylene about 11 um thickness, the intermediate layer C of the film is 9 um thickness of ethylene-propylene-butene-1 terpolymer having DSC melting point at 131° C., and the sealable skin layer D of the film is 1 um thickness of ethylene-propylene-butene-1 terpolymer having DSC melting point at 126° C. loaded with 2400 ppm SiO₂ about 4 microns size and 6000 ppm Epostar 1010, available from Nippon Shokubai Co., Ltd., which is a cross-linked copolymer of methylmethacrylate and propylidene trimethacrylate with average particle size about 10 microns.

The laminated film is evaluated by using a vertical form fill and seal machine, Fuji FW7700, at the speed of 55 packages per minute. Empty bags at the size 5″×7-½″ filled with air are sealed at the specified temperatures for fin seal at the back of the bag and crimp seal on both ends of the bag. The bags are put under water vacuum at 10 inches mercury. If there are no bubbles observed, the seal is considered hermetic seal or no leak. From crimp seal and fin seal temperatures combination, the data are generated to obtain the hermetic seal range (i.e. There is no leak in these temperature range). Hermetic seal range for the above laminated structure is observed when fin seal temperature is from 260° F. to 280° F. and crimp seal temperature is from 260° F. to 290° F.

### Comparative Example 2

A laminated film structure is prepared from four layer coextruded biaxially oriented film having layers A, B, C, and D. Layer A of the four layer film is laminated with polyethylene to an oriented polypropylene film (Mobil's 80MB400). The four layer coextruded biaxially oriented film is the same structure as Example 1. The laminate is run through the same packaging machine and same speed as Example 1. Hermetic seal range for the laminate is observed when fin seal temperature is from 250° F. to 290° F. and crimp seal temperature is from 260° F. to 290° F.

### Comparative Example 3

A laminated film structure is prepared from four layer coextruded biaxially oriented film having layers A, B, C, and D. Layer A of the four layer film is laminated with polyethylene to an oriented polypropylene film (Mobil's 70 SPW-L). The four layer coextruded biaxially oriented film is the same structure as Example 1. The laminated film is evaluated by using a vertical foam fill and seal machine, Hayssen Ultimum II, at the speed 55 packages per minute. Empty bags at the size 5″×7-½″ filled with air are sealed at the specified temperatures for lap seal at the back of the bag and crimp seal on both ends of the bag. Hermetic seal range is observed when lap seal temperatures is from 260° F. to 330° F. and crimp seal temperature at 310° F., and lap seal temperature is from 280° F. to 330° F. and crimp seal temperature at 300° F.

### Comparative Example 4

A metallized four layer coextruded biaxially oriented film is evaluated. The aluminum vacuum deposition is applied on the skin layer A of the structure A/B/C/D which is the same four layer coextruded biaxially oriented film structure as Example 1. This metallized film is further printed with ink on the top of aluminum layer and a heat resistance lacquer layer is coated on the top of the ink. The final layer structure is (heat resistance lacquer)//ink//(vacuum metallized aluminum)//HDPE//Polypropylene//EPB-terpolymer (I)//EPB-terpolymer (II), where EPB-terpolymer (I) is 9 um thickness of ethylene-propylene-butene-1 terpolymer having DSC melting point at 131° C., and EPB-terpolymer(II) is 1 um thickness of ethylene-propylene-butene-1 terpolymer having DSC melting point at 126° C. loaded with 2400 ppm SiO₂ about 4 microns size and 6000 ppm Epostar 1010, available from Nippon Shokubai Co., Ltd., which is a cross-linked copolymer of methylmethacrylate and propylidene trimethacrylate with average particle size about 10 microns. This over-lacquered, printed, and metallized film is run through horizontal form fill and seal machine, Doboy, at the speed 86 feet per minute or 172 packages per minute. Empty bags filled with air are generated. The hermetic seal range evaluation procedure is the same as Example 1. A hermetic seal range is observed when the crimp seal temperature is from 240° F. to 320° F. and fin wheel temperature is set at 320° F.

What is claimed is:

1. A thermoplastic multi-layer film for forming hermetic seals on packages comprising:
(a) layer B comprising polypropylene and a softening additive;
(b) layer C comprising a copolymer.

2. The film of claim 1, wherein the copolymer of layer C is selected from the group consisting of ethylene-propylene copolymer, ethylene-propylene-butene-1 terpolymer, propylene-butene copolymer, and mixtures thereof.

3. The film of claim 1 further comprising layer A comprising a material selected from the group consisting of high density polyethylene, medium density polyethylene, and mixtures thereof.

4. The film of claim 1 wherein the softening additive in layer B comprises a material selected from the group consisting of ethylene-propylene copolymers, terpolymers, thermoplastic hydrocarbons, hydrocarbon resins, and cyclopentadiene hydrocarbon.

5. The film of claim 1 wherein the softening additive in layer B comprises a hydrocarbon resin.

6. The film of claim 1 wherein the softening additive in layer B comprises cyclopentadiene hydrocarbon.

7. The film of claim 1 wherein the softening additive in layer B comprises from about 2% to about 15% by weight of layer B.

8. The film of claim 5 wherein the softening additive in layer B comprises from about 2% to about 15% by weight of layer B.

9. The film of claim 6 wherein the softening additive in layer B comprises from about 2% to about 15% by weight of layer B.

10. The film of claim 1, wherein the layer C thickness is from about 5 microns to about 10 microns.

11. The film of claim 1, wherein the thickness of the film is from about 17 microns to about 31 microns.

12. The film of claim 3, wherein the thickness of the film is from about 17 microns to about 31 microns; the layer C thickness is from about 5 microns to about 10 microns; the layer B thickness is from about 5 microns to about 25 microns; and the layer A thickness is from about 1 micron to about 10 microns.

13. The film of claim 1, wherein the film is biaxially oriented.

14. The film of claim 1, wherein the film is uniaxially oriented.

15. The film of claim 1, wherein the film is hermetically sealable in a machine for making packaging bags with a combination of a fin seal and crimp seals or a combination of a lap seal and crimp seals.

16. The film of claim 3, wherein the layer A is metallized.

17. The film of claim 3, wherein the layer A comprises high density polyethylene.

18. The film of claim 3, wherein the layer A comprises medium density polyethylene.

19. The film of claim 3 further comprising a coating applied to the layer A.

20. A thermoplastic multi-layer film for forming hermetic seals on packages comprising:
(a) layer B comprising polypropylene and a softening additive wherein layer B has a first side and a second side;
(b) layer C comprising a copolymer wherein layer C has a first side and a second side, wherein the first side of layer C is adjacent to the second side of layer B.

21. The film of claim 20 further comprising layer A comprising a material selected from the group consisting of high density polyethylene, medium density polyethylene, and mixtures thereof wherein layer A has a first side and a second side wherein the second side of layer A is adjacent to the first side of layer B.

22. A method of producing a thermoplastic multi-layer film comprising the steps of:
(a) coextruding a first layer comprising; a second layer comprising polypropylene and a softening; and a third layer comprising a copolymer;
(b) orienting the film in the machine direction at an elevated temperature.

23. The method of claim 22 further comprising the step of orienting said film in the transverse direction at an elevated temperature.

24. The method of claim 22 further comprising the step of corona said third layer.

25. The method of claim 22 further comprising the step of flame treating said third layer.

26. The method of claim 22 further comprising the step of plasma treating said third layer.

27. The method of claim 22 further comprising the step of priming said third layer.

28. The method of claim 22 wherein the film produced has a MST below 170 degrees fahrenheit.

29. The film of claim 1 wherein the film has a MST below 170 degrees fahrenheit.
